(19) United States
(12) Patent Application Publication
(10) Pub. No.: US 2006/0154195 A1
(43) Pub. Date: Jul. 13, 2006

(54) Shape memory polymer orthodontic appliances, and methods of making and using the same

(76) Inventors: Patrick T. Mather, Chagrin Falls, OH (US); Charles J. Burstone, Farmington, CT (US); Changdeng Liu, Belle Mead, NJ (US)

Correspondence Address: CANTOR COLBURN, LLP, 55 GRIFFIN ROAD SOUTH, BLOOMFIELD, CT, 06002, US

(21) Appl. No.: 11/301,795

(22) Filed: Dec. 12, 2005

Related U.S. Application Data
(60) Provisional application No. 60/635,199, filed on Dec. 10, 2004.

(51) Int. Cl. A61C 3/00

(52) U.S. Cl. 433/6

(57) ABSTRACT

Described are fixed and removable orthodontic appliances and components thereof fabricated from shape memory polymer compositions. The preparation and use of such appliances are also disclosed.

### CROSS REFERENCE TO RELATED APPLICATIONS

This application claims the benefit of U.S. Provisional Patent Application Ser. No. 60/635,199 filed Dec. 10, 2004.

### BACKGROUND OF THE INVENTION

Shape memory polymers (SMPs) are materials that have the ability to “memorize” a macroscopic (“permanent”) shape, be manipulated and “fixed” to a temporary or dormant shape under specific conditions of temperature and stress, and then later relax to the original, stress-free condition under thermal, electrical, or environmental command. This relaxation is associated with elastic deformation stored during prior manipulation.

While both shape memory alloys (SMAs, e.g., nickel-titanium alloys) and SMPs show similar thermo-stimulated shape memory properties, their mechanisms of action are quite distinct. Advantages of SMAs include rapid strain recovery (within 1 second), the potential training for two-way reversible memory, and an apparent superelasticity due within the austentite phase at low temperature. In contrast, polymers intrinsically exhibit shape memory effects derived from their highly coiled constituent chains that are collectively extensible via mechanical work, and this energy may be stored indefinitely (“shape fixed”) by cooling below the glass transition temperature, T_{g}, of an amorphous polymer, or the melting point, Tₘ, of a crystalline or semicrystalline polymer. After shape fixing, the polymeric sample can later perform mechanical work and return to a stress-free state when heated above the critical temperature, T_{crit}, mobilizing the frozen chains to regain the entropy of their coiled state. In comparison to SMAs, thermally stimulated SMPs have the advantages of large recoverable deformations in excess of several hundred percent strain, facile tuning of transition temperatures through variation of the polymer chemistry, and processing ease at low cost.

Orthodontic treatment refers to the straightening or moving of teeth using orthodontic appliances, the most common of which includes dental braces, removable aligner appliancess. Orthodontic appliances can be fixed or removable. Fixed appliances typically contain three general components: (1) passive structures, such as brackets, (2) active structures, including tooth moving springs and arch wires, and (3) combinations of active and passive elements, such as self-ligating brackets. Metallic materials have been the primary choice for most fixed appliances, although some polymers have been used for aesthetic brackets, elastomeric rings, and “chain elastics”. In contrast to passive elements, active appliance members rely on the elastic deformation of wires or polymers to develop the forces needed for tooth movement. SMAs have been used in orthodontic arch wires; however, this application usually takes advantage of the large deflections (superelasticity) of NiTi wires rather than a shape memory phenomenon, itself.

There remains a need in the art for orthodontic appliances that provide ease of application and use.

### BRIEF DESCRIPTION OF THE INVENTION

This invention is directed to the use of shape memory polymers in both fixed and removable orthodontic appliances, and to the preparation and use of such appliances.

In one embodiment, an orthodontic appliance or a component thereof, comprises a shape memory polymer.

In another embodiment, a method of making an orthodontic appliance comprises preparing an orthodontic appliance comprising a shape memory polymer by profile extrusion, injection molding, die cutting, casting, dip-coating, compression molding, blow-molding, rotational molding, rapid prototyping, solid freeform fabrication, or combinations thereof.

### BRIEF DESCRIPTION OF THE DRAWINGS

FIG. 1. Exemplary SMP permanent shape ligature (a) for use with a bracket where the SMP ligature having a secondary snap-on shape is placed on the bracket as in (b); the original “permanent” shape is then recovered to secure the arch wire to the bracket as in (c).

FIG. 2. Exemplary SMP self-ligating bracket: The SMP cap is snapped in place at the lower portion of the bracket (a); heating leads to shape recovery, closing the bracket in a self-ligating manner; and cooling back to mouth temperature rigidifies the bracket.

FIG. 3. Exemplary SMP force module with T_{crit}<about 37° C., placement between hooks, or other attachments, in the mouth will lead to force generation.

FIG. 4. Exemplary SMP torque actuation module: a superelastic metallic wire coated with an SMP is heated, pre-torqued, and cooled to fix the torsional deformation; securing the appliance between brackets and heating actuates a torque (moment) for relative tooth torque.

FIGS. 5a-b. Exemplary metal wire spring coated with an SMP; upon heating, adjacent teeth are brought closer together.

FIG. 6 illustrates the dynamic water absorption data for a castable SMP.

FIG. 7 illustrates tensile stress-strain behaviors of dry (A) and water saturated (B) CSMP at room temperature.

FIG. 8 illustrates water uptake results of materials using thermogravimetric analysis (TGA).

FIG. 9 illustrates the tensile mechanical properties of a castable SMP.

FIG. 10 illustrates the room temperature mechanical properties of crosslinked polycyclooctene.

FIG. 11 illustrates the stress-strain behavior of thermally and radiatively crosslinked polycyclooctene.

FIG. 12 Short term stress relaxation of several crosslinked PCO samples. All samples were stretched to 100% strain and relaxations of stress with time were recorded. A relaxation of less than 10% and fast relaxation at the first hour followed by an equilibrated stress were observed.

FIG. 13 Long term stress relaxation (1 week) of a chemically crosslinked PCO sample (cured with 1% DCP). 10.4% stress loss and fast stress equilibrium were observed. Stress oscillation with time might be due to the temperature fluctuation.

FIG. 14 Long term stress relaxation (1 week) of a commercially available O-ring.

### DETAILED DESCRIPTION OF THE INVENTION

Orthodontic treatment is accomplished by generating a desired force system in an incrementally changing geometry of tooth positions. Sequential variable production of these force systems (activations) can be simplified, optimized, clinically more easily applied, can be made more esthetic and comfortable, with a reduction of the number of patient visits and treatment time with the use of Shape Memory Polymers (SMPs) that can be reactivated depending on the biologic conditions.

Disclosed herein are new apparatus and methods for performing orthodontics using SMPs. These apparatus have the ability to memorize two shapes: a permanent shape (“equilibrium shape”) and a secondary shape (“temporary shape”). The return of the SMP toward its equilibrium shape can be accompanied by a sufficient and prescribed force, useful for an orthodontic force module, and/or macroscopic shape change, which is useful for ligation mechanisms. Due to the SMP's ability to have two shapes, these devices meet needs unattainable with current orthodontic apparatus materials allowing for easier and more comfortable orthodontic operation for the orthodontist to insert into the mouth of the patient. The SMP orthodontic devices can provide improvements over traditional orthodontic device materials as they will provide lighter, more constant forces which in turn may cause less pain for the patients. Furthermore, the SMP materials are clear, colorable, and/or stain resistant, providing the patient a more aesthetically appealing appliance during treatment. The high percent elongation of the SMP appliance (up to about 300%) allows for the application of continuous forces over a long range of tooth movement and hence, results in fewer visits for the patient.

Furthermore, use of SMPs to fabricate orthodontic appliances have a number of advantages over SMAs. SMPs can be developed to feature a wide range of transition temperatures as dictated by their intended application. They can be fabricated into complex configurations and specialized designs. They are more aesthetically pleasing than metal wires and attachments. Finally, manufacturing techniques allow SMP orthodontic appliances to be produced at a low cost.

Generally, the shape memory cycle of an SMP apparatus can be described as follows. A sample of SMP is heated to a compliant state (T>T_{crit}) and manipulated (e.g., stretched, bent, twisted, etc.) to what will become a temporary shape. Once the desired manipulated shape is obtained, the sample is cooled under constraint to allow “fixing”, by crystallization, vitrification, or other solidification mechanism, and the constraint released. To complete the cycle, the fixed SMP is heated above the same T_{crit} to trigger recovery of the equilibrium state as driven by rubber elasticity (hereinafter referred to as “activating” the shape memory polymer).

While the rigidity of SMPs in the rubbery state (E(T), T>T_{crit}, E=tensile modulus) is dictated by the crosslinking density (E∝νkT, where ν is the elastic chain crosslink density, k is Boltzmann's constant, and T is absolute temperature), the vitrification or crystallization of this elastic phase controls the “locking” of the polymer chains and, therefore, allows setting of an arbitrary secondary shape during fixing. As such, control over T_{crit}, crosslinking density (chemical or physical), and phase behavior by variation of composition or processing history provides the means to control SMP properties.

SMPs generally exhibit i) a sharp transition that can be used to quickly fix the secondary shape at low temperature and trigger shape recovery at high temperature; ii) superelasticity (low loss modulus, high deformability) above the transition temperature that leads the shape recovery and avoids residual strain (permanent deformation); and iii) complete and rapid fixing of the temporary shape by immobilizing the polymeric chains without creep thereafter.

Various exemplary SMPs include glassy materials having a storage modulus greater than about 1 GPa, with the secondary (temporary) shape fixed by vitrification and shape recovery triggered by glass transition temperature (T_{g}); a semicrystalline elastomer having tensile storage modulus of about 10<E′<about 500 MPa, specifically about 15<E′<about 400 MPa, and more specifically about 50<E′<about 200 MPa, with the secondary (temporary) shape fixed by crystals and shape recovery triggered by crystal melting temperature (Tₘ), and the like.

The mechanical properties of SMPs can be further enhanced to about 5 GPa by incorporation of rigid fillers. The rubbery modulus, which controls the work capability during shape recovery, can be adjusted to any value from about 1 MPa to about 10 MPa, depending on application requirements and, by adjusting the extent of crosslinking (“crosslinking density”). Here, the modulus is measured from the slope of engineering tensile stress versus engineering tensile strain at small strains, as specified in ASTM D882 “Standard Test Method for Tensile Properties of Thin Plastic Sheeting” for films and ASTM D412-98a(2002)e1 “Standard Test Methods for Vulcanized Rubber and Thermoplastic Elastomers; Tension” for elastomers.

SMPs can be either chemically (permanently) crosslinked or physically crosslinked. Physical crosslinking can be achieved by crystal formation, hydrogen bonding, ionomeric domain formation, glassy domains in block copolymers, and the like. The benefit of the use of physical crosslinking is that the permanent shapes can be reset multiple times by processing above the transition temperature of the hard domains, such as the melting of crystals, glass transition of hard segments, or the disorder temperature of the ionomeric domains. Furthermore, traditional processing methods of extrusion and injection molding can be applied for economical production. Chemical crosslinking has the advantage of excellent shape recovery, although the permanent shape, set by chemical crosslinking, cannot be reprogrammed once set.

For orthodontic appliances, depending upon the particular application, the targeted transition temperature of the SMP, and the appliance fabricated thereby, can be selected for maximum effect. For example, SMP force modules, discussed in further detail herein, can be triggered at body temperature (37° C.), e.g., about 28 to about 33° C. (transition temperature). Other applications such as SMP ligatures and self-ligating brackets may be prepared from SMPs having a target transition temperature that is higher, such as greater than 50° C., ensuring avoidance of failure due to exposure to hot foods and beverages.

Exemplary orthodontic appliances that can be fabricated from SMPs include ligatures, self-ligating brackets, force modules, torque modules, removable aligner appliances, arch wires, and the like.

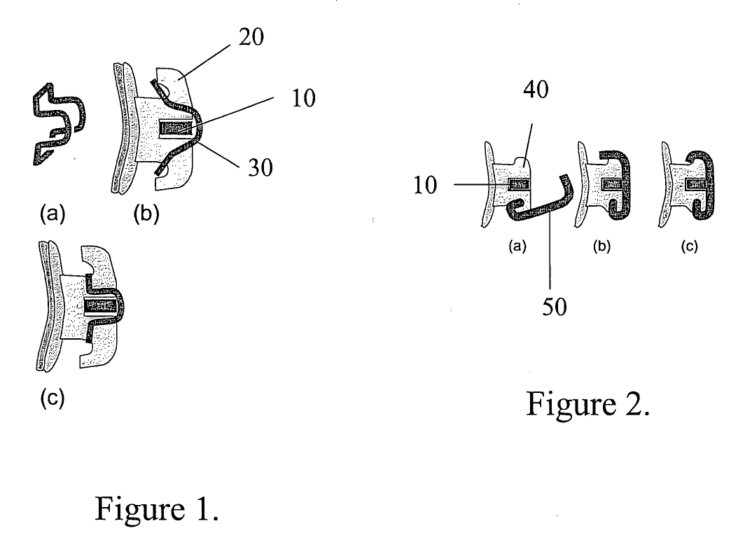

Ligatures (including “O-rings”) are used to hold the arch wires (10) in the brackets (20) that are adhered to a tooth (not shown in FIG. 1). An exemplary permanent shape of an SMP ligature (30) can be set as a closed loop “Q” shape. When the ligature is being used, it will be heated above its transition temperature, and thereby assume its permanent shape and then cooled. The ligature is thus fastened by heating the SMP to the transition temperature to trigger the shape recovery (FIG. 1(c)). Optionally, a specialized heating tool may be used.

A self-ligating bracket is a bracket and a ligature as a unit. An exemplary SMP self-ligating bracket (see FIG. 2) can comprise a cap (50) prepared from an SMP having a permanent shape set to a desired shape, e.g., a “C” shape (FIG. 2a). The “up” cap can be opened by straightening in the rubbery stage for easy operation; the cap is then closed and thermally triggered to fasten it to the bracket (40). Exemplary SMP materials used to prepare a self-ligating bracket can have a transition temperature greater than 40° C., specifically about 42 to about 55° C., and more specifically about 43 to about 45° C.

A force module is an auxiliary device that supplies the required forces to produce biologic tooth movement by bone remodeling. For example, an orthodontic device that is stretched between two hooks on support brackets, thus applying a force between those two points in order to impart relative tooth movement. A SMP force module can be an elastic spring, which may or may not be in coiled form, which adjusts tooth position. The SMP can be tuned to have a sharp, defined transition, for example from about 28 to about 39° C., or about body temperature. Optionally, temperatures greater than about 39° C. can be used.

Outside the mouth, the force module can be pre-stretched from an initial length to various lengths (of a set). This secondary shape can then fixed by cooling (e.g., dipping in ice water) and stored and packaged for distribution in secondary form. When applied in the mouth, the shape recovery is triggered by heating (e.g., mouth temperature about 37° C., or greater), resulting in an applied force that leads to tooth positioning as with chain elastics. The SMP force module is an improvement over so-called “chain elastics” in that it is easy to apply and the range of forces is not dictated solely by geometry. In particular, the applied force can be adjusted by the rubbery modulus (E′), the actual strain, and the cross-sectional area. In addition, it can be deflected further without permanent deformation (elongation) and has greater stain resistance.

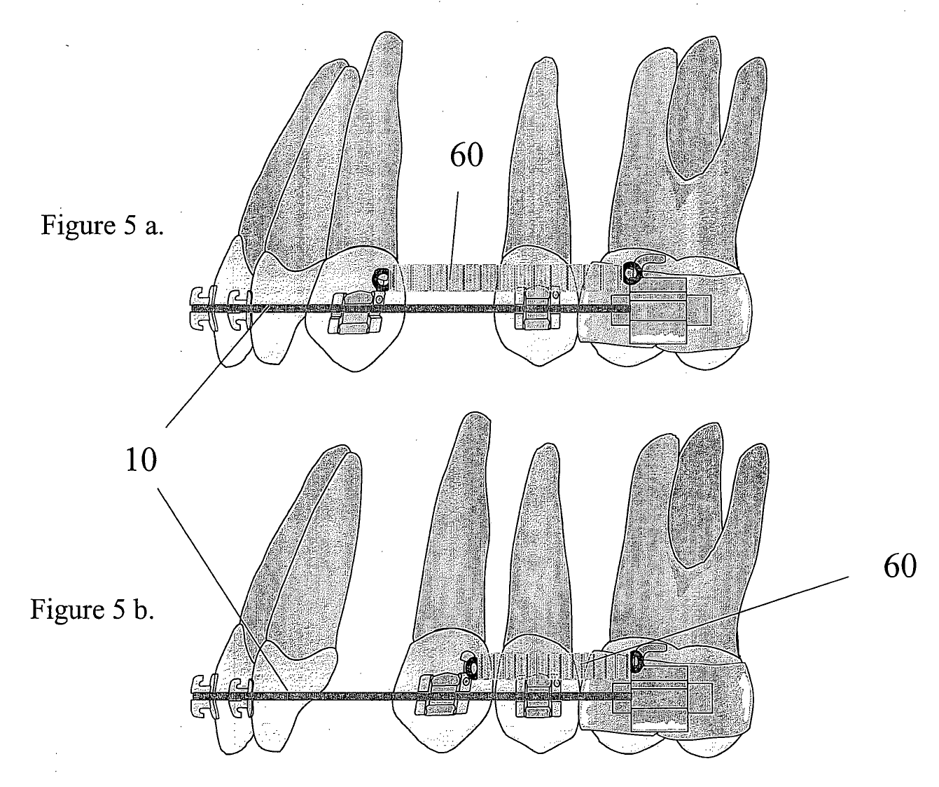

Another type of force module can comprise the combination of a SMP and a wire, for example a SMA metal wire spring coated with a SMP (FIG. 5). As illustrated in FIGS. 5a to 5b, the SMP coated metal wire spring (60) can be used to provide tooth provide tooth movement as in closing an extraction space. This allows the use of the heavier force from the metal spring, ease of activation by mouth temperature, and beneficial oral hygiene by the SMP coating of the metal spring.

A torque module (also referred to as a torque actuation module) is a force system that produces a pure moment or torque. Exemplary SMP torque modules can comprise a combination of an SMP and a superelastic or other metals wire. An exemplary structure can be achieved by coating a shape memory polymer, (e.g. the castable SMP that is amenable to a coating process described herein-below), around a thin metal wire. SMA, such as NiTi alloys, can be used for the metal wire. The coated wire can be heated up to the SMP's transition temperature and twisted to a secondary shape. This secondary shape can be further completely fixed by vitrification of the SMP with torque applied. When the torque is released, the vitrified SMP will hold the secondary shape from recovering. This deformed wire can then inserted between brackets and the stored torque actuated by heating the polymer above its transition again. This process can adjust buccal-lingual or labio-lingual axial inclination of the tooth.

SMPs used to fabricate the torque module apparatus exhibit high storage modulus and toughness. These properties can be enhanced by blending rigid fillers, either isotropic fillers, such as silica, calcium carbonate, titanium dioxide, or anisotropic fillers, such as glass fibers, boron nitride, clay, or carbon nanotubes with the SMP. The high storage modulus will minimize the SMP thickness (and appliance profile) to help resist the superelastic wire torque, storing the torsional elastic energy.

Orthodontic arch wires can be prepared from SMP materials. Such wires can be inserted in the brackets below the applicable SMP transition temperature, which can be mouth temperature for example. When the transition temperature is reached, the wire changes shape to produce tooth alignment.

One embodiment is directed to removable aligner appliances (“aligners” or “tooth positioners”) prepared from a shape memory polymer. A removable appliance is not fixed to the patient and can be removed by the patient or the orthodontist for cleaning and adjustment. Components of the removable appliance include an anchorage base attached to the teeth and soft tissues, clasps and wires for retention and tooth movement, and in some cases a tray enclosing the entire crown of the teeth to exert tooth moving forces. In one embodiment, the removable aligner appliance can be prepared from SMP materials located through the appliance, for example in the form of a wire or band of SMP material running the length of the appliance. In another embodiment, the removable aligner appliance comprises discrete sections of SMP material wherein each can optionally be activated at different temperatures. The activation can occur by removing the appliance from the mouth of the patient, activation of a portion or all of the SMP located in the appliance (e.g. by the application of heat) either by the orthodontist or technician for example followed by reintroduction of the appliance to the mouth of the patient for continued treatment.

An advantage of using SMP materials in the removable aligner appliance is that fewer appliances need to be fabricated. A single appliance can contain different sections of SMPs that can be activated at different times and/or temperatures to provide the desired forces at the appropriate times or sequence during treatment.

Several types of SMPs can be fabricated into orthodontic appliances including, for example, glassy thermosets, thermoplastic blends, semicrystalline elastomers, thermoplastic polyurethanes, and their blends or composites.

Castable Glassy Thermoset SMPs

Castable glassy thermoset SMPs include glassy thermosets featuring a sharp T_{g}, which can be just above room temperature, and a rubber elasticity above T_{g} derived from covalent crosslinks. This SMP can be a liquid-castable crosslinked copolymer synthesized using two monomers that show similar reactivity and whose homopolymers show two very different transition temperatures. An exemplary SMP of this type includes a copolymer comprising butyl methacrylate (homopolymer T_{g}=20° C.) and methyl methacrylate (homopolymer T_{g}=120° C.), which can be chemically crosslinked by a difunctional methacrylate serving as an amorphous crosslinking agent (e.g., tetraethyleneglycol dimethacrylate). The copolymer itself gives a single transition temperature that is tunable between the two transition temperatures of the homopolymers by varying the feed compositions. The storage modulus of such SMPs can be enhanced by the inclusion of solid fillers.

The castable glassy thermoset SMP has the advantage of exhibiting complete shape fixing, R_{f} of about 100%, where R_{f}=(Lᵤ−Lᵢ)/(Lₜ−Lᵢ)×100%, with Lᵢ=equilibrium length without load and above T_{crit}, Lₜ=length under load and above T_{crit} and Lᵤ=“fixed” length after cooling below T_{crit} and unloading. The castable glassy thermoset SMP further have the advantage of exhibiting fast and complete shape recovery, Rᵣ of about 100%, where Rᵣ=(Lᵤ−L_{f})/(Lₜ−Lᵢ)×100%, with L_{f}=final length after heating above T_{crit} and other lengths defined as above. These characteristics are ideal for orthodontic applications, specifically complex-shaped ligatures, brackets, and torsion modules. Since these materials are castable, complex ligatures and brackets can be prepared in addition to coating NiTi wires for particular application as torsion modules. Furthermore, the castable glassy thermoset SMPs have the added advantage of being optically transparent for the preparation of discrete orthodontic appliances, or optionally to be colored to an aesthetically pleasing color.

Suitable castable shape memory polymers include those disclosed in application Ser. No. 10/425,451 entitled “Castable Shape Memory Polymers”, filed Apr. 29, 2003 incorporated by reference herein in its entirety. By copolymerizing two monomers, each selected from the categories of vinyl monomers, vinylidene monomers, and alkyl methacrylates castable shape memory polymers can be formed that have quite different glass transition temperatures than those associated with either of their homopolymers, and that incorporate a multifunctional monomer into the polymerization reaction so that the copolymer is crosslinked during polymerization to form a thermoset network.

In addition to the two monomers selected from vinyl, vinylidene and alkyl methacrylate monomers and the multifunctional cross-linking agent, an initiator such as an organic peroxide or an azo compound is present. The preparation of a castable shape memory polymer includes the use of a mixture of two or more monomers, plus a crosslinking agent, with at least one selected monomer being from each of the categories, high-T_{g} polymer-forming and low-T_{g} polymer-forming.

Exemplary high-T_{g} polymer-forming monomers include the following: vinyl chloride, vinyl butyral, vinyl fluoride, vinyl pivalate, 2-vinylnaphthalene, 2-vinylpyridine, 4-vinyl pyridine, vinylpyrrolidone, n-vinyl carbazole, vinyl toluene, vinyl benzene (styrene), methyl methacrylate, ethyl methacrylate, acryl-functionalized POSS, and methacryl-functionalized POSS, among others. (POSS refers to various polyhedral oligosilsesquioxanes several of which are commercially available from Hybrid Plastics, Inc.).

Exemplary low-Tg polymer-forming monomers include: vinyl ethyl ether, vinyl laurate, vinyl methyl ether, vinyl propionate, alkyl acrylates (methyl acrylate, ethyl acrylate, propyl acrylate, butyl acrylate), and alkyl methacrylates (propyl methacrylate, butyl methacrylate).

Exemplary multifunctional monomer or crosslinking agents include diacrylates: propoxylated neopentyl glycol diacrylate, polyethylene glycol diacrylates with different glycol length, such as diethylene glycol diacrylate, polyethylene glycol 200 diacrylate, polyethylene glycol 400 diacrylate; polyethylene glycol dimethacrylates, such as ethylene glycol dimethacrylate, diethylene glycol dimethacrylate, polyethylene glycol 200 dimethacrylate, polyethylene glycol 600 dimethacrylate; 1,3-butanediol dimethacrylate, 1,4-butanediol diacrylate, 1,4-butanediol dimethacrylate; tri(meth)acrylates, tetra(meth)acrylates, triacrylates and tetraacrylates, such as glyceryl proxy triacrylate, pentaerythritol tetraacrylate, tetraethylene gycol dimethacrylate and multacryl- or multimethacryl-POSS. Specifically, the crosslinking agent is a difunctional monomer and more specifically it is tetraethylene glycol dimethacrylate (TEGDMA).

The crosslinking provides complete shape recovery, Rᵣ. Incomplete shape recovery (in the range 50-90%) can be obtained without crosslinking, increasingly so for molecular weights greater than 100 kg/mol, but especially greater than 250 kg/mol.

The amount of crosslinking agent is very broad, ranging from 0.3% up to 10% by weight, the exact value dictating the mechanical energy stored during formation of the temporary shape.

As thermal initiators there may be used such initiators as will dissolve into the monomers, including for example tert-amyl peroxybenzoate, 1,1′-azobis(cyclohexanecarbonitrile), benzoyl peroxide, lauroyl peroxide, 4,4-azobis(4-cyanovaleric acid), tert-butylperoxy isopropyl carbonate, and potassium persulfate and preferably 2,2′-azo-bis butyronitrile.

Generally speaking, the monomers can be used over a broad range of amounts and will provide shape memory polymers having attractive shape memory properties, covering a broad ranges of transition temperatures to be selected based on their intended application. Suitable composition ranges for orthodontic applications, where a range of transition temperatures can be in the proximity of body temperature (T=37° C.), are: butyl methacrylate (BMA) from 60 to 80%, methyl methacrylate (MMA) from 20 to 40%. These ranges give sharp glass transitions between 30 and 60° C., independent of the crosslinker used for percentages less than 10%. Copolymers of MMA-BMA are stiff (glassy) below T_{g} with a storage modulus about 2 GPa. The T_{g} (=T_{crit}) can be tailored from about 20 to about 110° C., depending on the composition of the copolymer, specifically about 37 to about 80, and yet more specifically about 47 to about 60° C.

The amount of initiator can be about 0.1% to about 2% and specifically about 0.2% to about 1%. If no crosslinker is used, the amount of initiator can be about 0.05% to about 0.25% to yield high molecular weight polymers.

The transition temperature (T_{g}) can be adjusted by the ratio of the monomers, while the degree of crosslinking controls the rubbery modulus plateau. The latter, in turn, dictates the energy stored during a given deformation and thus the energy that is available to release when the polymers recover. The transition temperature can be adjusted to be about 20 to about 110° C.

These SMPs can be processed as castable formulations in the form of coatings and films. Further they are optically transparent and colorless. Exemplary applications of castable SMP is for self-ligating brackets and ligatures.

Semicrystalline Rubber (SR) SMPs

Semicrystalline rubber SMPs can also be employed to trigger shape recovery, giving a sharp recovery event. The secondary shapes of SR SMPs are fixed by the formation of crystals instead of being fixed by vitrification. The permanent shapes are established by chemical crosslinking and cannot be reshaped after the processing. Compared with glassy materials, this class of materials is generally more compliant below the critical temperature, with a stiffness that is sensitive to the degree of crystallinity, and thus indirectly to the extent of crosslinking.

An exemplary SR SMP includes chemically or radiatively crosslinked semi-crystalline trans-polyoctenamer (polycyclooctene, PCO). A PCO with a trans-content of about 80%, a T_{g} of −70° C. and a Tₘ of 58° C. has been shown to be exceptionally resilient during shape recovery, rendering it useful for the fabrication of SMP force modules. It is the significant rubbery modulus that allows the SR SMP to apply a force. Again, the rubbery modulus can be tailored by the extent of cure and by additives.

In force module applications, the mouth temperature exceeds the transition temperature of the SMP so that shape recovery occurs during application and the material applies a force continuously between two bracketed teeth. The room temperature stiffness of the SR SMP can be set at about 10 to about 300 MPa using the addition of two types of additives: a rigid filler that reinforces the elastomer and a rubber that softens it (yielding “shape memory rubber”). The transition temperatures can be tuned from about 20 to about 45° C. by crosslinking to varying levels and a miscible second composition, specifically a PCO of lower trans-content or poly(ethylene-co-vinylacetate) (EVA) copolymers. Exemplary PCO materials exhibit a controllable rubbery modulus, and thus recovery force, that can be set to span a broad range of about 0.5 to about 5 MPa.

Suitable crosslinked polycyclooctene shape memory polymers include those disclosed in application Ser. No. 10/683,559 entitled “Crosslinked Polycyclooctene”, filed Oct. 10, 2003 incorporated by reference herein in its entirety. It has been found that chemically cross-linked polycyclooctenes (PCOs) synthesized from cis-cyclooctene have a high trans double bond content. This polymer can be chemically crosslinked with variations in crosslink density to form semicrystalline thermoset SMPs. The polymer synthesis can be conducted via ring-opening metathesis polymerization of cyclooctene using a dihydroimidazolylidene-modified Grubbs catalyst. The PCO formed can then be cured by adding an organic peroxide, such as dicumyl peroxide, to the PCO and the mixture compression molded into a film and further cured through chemical crosslinking upon heating. The effects on the thermal, mechanical, and microstructural properties of the synthesis product depends on the extent of crosslinking.

Alternatively, the polycyclooctene can be crosslinked by exposing the uncrosslinked polymer to an electron beam or electromagnetic radiation having a wavelength ranging from about 0.1 picometer (i.e., gamma radiation) to about 400 nanometers (i.e., ultraviolet irradiation). For example, an absorbed dose of gamma radiation per sample, suitable for crosslinking, can be about 100 kilogray (kGy) to about 400 kGy, specifically 100 kGy about to about 400 kGy, and yet more specifically about 150 kGy to about 350 kGy.

A particular advantage of radiation crosslinking versus chemical crosslinking include 1) the crosslinking is an ambient temperature process, allowing for the preservation of crystallinity and leading to a sharper transition and better mechanical properties for T<Tₘ; 2) complex shapes can be easily manipulated and set as the equilibrium shape by manipulation above Tₘ and fixing via crystallization before crosslinking; 3) processing is simplified; and 4) no thermal initiator is needed, avoiding the odor often associated with residual initiator.

The transition temperature of the PCO is tunable through the change of trans/cis ratio of vinylene groups and blending with miscible rubbers. A soft shape memory behavior is observed, where the primary stress-free shape can be recovered within 1 second on immersion in hot water above the melting point of the crystalline PCO phase. In contrast with glassy shape memory polymers, chemically crosslinked PCO behaves as an elastomer capable of arbitrary shaping above the sharp melting temperature of the PCO crystalline phase and subsequent shape fixing during crystallization. The SR SMPs exhibit excellent shape recovery effect with the recovery temperature and retracting force being adjustable from about 20° C. to about 60° C. according to the ratio of the tacticity used, the degree of curing and the thermal properties of the blended components. The recovery can be finished within 1 second when heated to about 20° C. above the transition temperature. Additional advantages of the SMPs include that the materials are flexible at room temperature, the flexibility can be tailored according to application requirements by blending with either rigid particulate filler or soft polymeric rubber, they can be dyed to any color according to application requirements, and an optical clearing transition may accompany triggered strain recovery.

The present disclosure also includes shape memory polymers formed by blending the disclosed PCOs with other exemplary polymer materials, e.g., styrene-butadiene rubber, ethylene propylene-diene (EPDM) rubber, natural rubber (cis-polyisoprene), polydimethylsiloxane (silicone), polyurethane polymers, and the like.

PCO polymers have been prepared with control over the cis/trans double bond composition and molecular weight afforded by the use of ruthenium catalysts. Samples of the polymers were cured using dicumyl peroxide of varying concentration and the influence of crosslinking on thermal, microstructural, and thermomechanical properties determined. In addition, the dependence of desirable shape memory characteristics on degree of crosslinking was investigated, revealing competing influences of crystallinity for shape-fixing, seen to decrease with crosslinking, and rubber elasticity above Tₘ, observed to increase with crosslinking as expected. While neat, linear PCO does not exhibit shape memory effect due to the lack of a rubbery plateau above melt transition temperature, a small amount of peroxide-crosslinking imparts shape memory effect to PCO. A fast shape memory effect was observed for the crosslinked PCO that results when crystallization-fixed distorted samples were submerged in a warm water bath. In the case of PCO containing either 2.5 or 5% peroxide, complete shape recovery from a curvature, κ=0.14 mm⁻¹ (ring with diameter, D=14.3 mm), to zero curvature occurs within 0.7 s at 70° C.

Various blends of PCO and other polymers including styrene-butadiene random copolymer (SBR), poly(ethylene vinyl-acetate) (EVA), and polyurethane using different ratios of the polymers in the blends were prepared and evaluated for isothermal characterization of the stiffness, thermomechanical melting and other properties per se and in comparison with PCO, EVA, SBR, polyurethane in unblended form.

The body-temperature stiffness and the transition temperatures of the PCO can be modified by blending with compatible components, such as PCO with different tacticity. In addition to SBR, EVA and other PCO starting materials, shape memory polymers can be prepared using various rubbery polyurethanes as the second material in the blend.

The body-temperature modulus of crosslinked PCO materials may be substantially increased through the addition of inorganic or organic filler powders. Exemplary fillers that can afford tailoring of tensile storage modulus, tensile loss modulus, and linear strain (the strain beyond which elasticity is lost), include boron nitride, silica, titanium dioxide, montmorillinite clay, Kevlar® staple, aluminum nitride, barium, and bismuth subcarbonate. Fillers of exceptionally high thermal conductivity, such as boron nitride, have been demonstrated to improve the rate of shape recovery in the shape memory effect by decreasing the time for the article to reach thermal homogeneity.

By manipulating the tacticity of PCO for the chemically crosslinked PCO, or blending with a second composition (e.g., a second PCO with a different tacticity), the stiffness, transition temperature, and the work capability (force generation) during shape recovery can be independently tuned. Since this material is elastic above its transition and the transition itself can be tailored to be room temperature fixable and body temperature triggerable (about 25° C. to about 37° C.), this material can be fabricated into auto-fastenable rings (ligatures) and, thus, a substitute for the conventional elastomeric-ring and chain elastics that are presently used in orthodontics.

PCO-based SMP force modules exhibit a range of possible forces of about 0.1 to about 0.5 N. The forces generated depend on the cross-section chosen, the strain after recovery, and the polymer's rubber modulus, as shown in Table 1.

TABLE 1
Force generated in a force module with a square cross section of
1 mm × 1 mm (Poisson ratio = 0.5)

| Fixed Strain (%) | Modulus (MPa) | Force Generated (N)* |
|---|---|---|
| 20 | 2 | 0.4 |
| 100 | 2 | 2 |
| 100 | 1 | 1 |

*Force = modulus (Pa) × strain × cross area (m²)

These forces are suitable for tooth movement.
Thermoplastic Blend (TB) SMPs

TB SMPs provide the advantage in that they can be processed by extrusion or injection molding. With TB SMPs, in comparison to the thermosets previously described, physical rather than chemical crosslinks are used to yield sufficient elasticity above T_{g}. Crystalline or rigid amorphous domains (e.g., about 10% by volume) in thermoplastics may serve as physical crosslinks affording super-T_{g} elasticity required for shape memory to be developed, mainly in the form of phase separated block copolymers. Beyond the melting point or glass transition of the physical crosslink domains, the material can be processed and reshaped as a liquid. Another, continuous phase (e.g., about 90% by volume) having a lower Tₘ or T_{g} (symbolized as T₁) exists that allows fixing of the secondary shape on cooling to T<T₁.

This SMP class further includes some low crystallinity semicrystalline homopolymers, or melt-miscible polymer blends that are compatible in the molten and amorphous states but have at least one semicrystalline component. In such a system, the crystals serve as physical crosslinks (or hard domains) and the composition-dependent T_{g} of the amorphous region yields the transition temperature. For these miscible blends, the glass transition temperature of the amorphous phase and the work output during shape recovery can be easily tuned by changing the blend composition, analogous to the copolymer thermosets as mentioned above. For some block copolymers and polyurethanes, this “soft” domain shows a sharp glass transition that can be tuned to be useful for shape memory. The room temperature stiffness of these SMPs is similar to the glassy thermosets described above, but with the advantage of being processable above the Tₕ of the hard domains. Here, Tₕ is either Tₘ or T_{g} of the hard domains, whether crystalline or glassy, respectively.

Suitable shape memory polymers containing amorphous and semicrystalline polymers include those disclosed in application Ser. No. 10/683,558 entitled “Blends of Amorphous and Semicrystalline Polymers Having Shape Memory Properties”, filed Oct. 10, 2003 incorporated by reference herein in its entirety.

SMPs containing blends of amorphous and semicrystalline polymers have a relatively high modulus in the fixed state at room temperature, have a tunable and sharp transition, the permanent shape of which can be remolded repeatedly above certain melting temperatures. Such polymer blends can be prepared by the blending or mixing of a crystalline polymer (C) with an amorphous polymer (A), such that they are a single miscible phase in the molten state (only possible for select polymer pairs; allowing processing to stress-free native states), but crystalline to a limited and tailored extent and which further vitrify on cooling to room temperature. The blends may further comprise plasticizers, finely divided particulate material, such as clay, silica or TiO₂.

Exemplary crystalline polymers (C) include: poly(vinylidene fluoride) (PVDF) (T_{g}=−35° C., Tₘ=175° C.), polylactide (PLA) (T_{g}=56° C., Tₘ=165° C.), and its copolymers such as poly(L-lactide), poly (D,L-lactide, poly(lactide-co-glycolide), poly(lactide-cocaprolactone), poly(lactide-co-1.5-dioxepan-2-one), poly(lactide-co-trimethylene carbonate), polyglycolide, poly(3-hydroxy butyrate) and its copolymers, polyanhydrides, poly(ethylene glycol) (PEG), polyethylene, polyethylene-co-vinyl acetate, poly(vinyl chloride) (PVC), and poly(vinylidene chloride) (PVDC) and copolymers of poly vinylidene chloride (PVDC)/poly vinyl chloride (PVC). Examplary amorphous polymers (A) include: poly(vinyl acetate) (PVAc) (T_{g}=35° C.), poly(methyl acrylate) (PMA), poly(ethyl acrylate) (PEA), atactic poly(methyl methacrylate) (aPMMA), isotactic poly(methyl methacrylate) (iPMMA), syndiotactic poly(methyl methacrylate) (sPMMA), and other poly alkyl methacrylates.

Exemplary SMP blends can be achieved by blending or mixing amorphous poly (vinyl acetate) (PVAc) (T_{g}=35° C.) with semicrystalline polylactide (PLA) (T_{g}=56° C., Tₘ=165° C.) or poly (vinyldiene fluoride) (PVDF). These polymers show complete miscibility at all blending ratios with a single glass transition temperature, while crystallization (exclusive of PVAc) is partially maintained. The T_{g}'s of the blends are employed as the critical temperature for triggering the shape recovery while the crystalline phases function as physical crosslinking sites for elastic deformation above T_{g}, but below Tₘ.

Specific polymer blends can be formed from poly(vinyl acetate) (PVAC) and poly(lactic acid) (PLA) or poly(vinylidene fluoride) (PVDF). However, examples of other suitable blends include the pair PVDF/PMMA and ternary blends of PVDF/PMMA/PVAc. The PMMA and the combination of PMMA/PVAc serve the same role as PVAc in the blends as has been previously described. An advantage of adding PMMA is that the critical temperature can be increased arbitrarily to about 80° C. and the room temperature modulus can also be increased. The PVDF may be substituted by poly(vinylidene chloride) (PVDC), by copolymers of poly(vinylidene chloride/poly(vinyl chloride), or by any “C” polymer discussed previously.

It has further been found that blending or mixing poly(vinyl chloride) with poly(butyl acrylate) (PVC/PBA) or poly(butyl methacrylate) (PVC/PBMA) has certain advantages. In the PVDF/PVAc case, PVAc simultaneously lowers the crystallinity of PVDF while increasing T_{g}. PVC may serve the same role as PVDF, but it already has a low degree of crystallinity, and a relatively high T_{g} (about 80° C.). Thus, in this exemplary embodiment of the present disclosure, the second component (PBA) serves only the function or role of decreasing T_{g}. This function/role can also be achieved with small molecule plasticizers, most notably dioctylphthalate (DOP). The range of PBA compositions can be about 10 to about 40%, specifically about 20%, yielding a T_{g} of about 40° C.

The shape recovery temperatures of particular polymer blends depend on the glass transition of the blends. The blended polymer will recover above the glass transition temperature and below the melting temperature. Temperatures that are on the order of about 20° C. above the glass transition temperature are preferably used to make the shape recovery fast. More specifically, a temperature in the rubbery plateau region for the particular polymer blend is selected in order to have a fast recovery and a predictable and desired retracting force.

A method of preparing a SMP blend material characterized by a T_{g} exceeding room temperature whose rubber modulus and elasticity is derived substantially from physical crosslinking comprises melt blending a crystalline polymer selected from the group consisting of poly(vinylidene fluoride), polylactide, poly(hydroxybutyrate), poly(ethylene glycol), polyethylene, polyethylene-co-vinyl acetate, poly(vinyl chloride), poly(vinylidene chloride) and copolymers of poly vinylidene chloride and poly vinyl chloride with an amorphous polymer selected from the group consisting of poly(vinyl acetate), poly(methyl acrylate) poly(ethyl acrylate), atactic poly(methyl methacrylate), isotactic poly(methyl methacrylate), and syndiotactic poly(methyl methacrylate) at a temperature of about 10 to about 20° C. above the melting temperature of the crystalline polymers, for a time sufficient to ensure good mixing, cooling the resultant blend to room temperature, introducing said blend into a press maintained at a temperature above the melting point of the crystalline component, applying pressure to said blend and then cooling the film thereby formed to an annealing temperature T_{g}<Tₐ<Tₘ, where it is held until crystallization is complete and following which the film is cooled to room temperature.

Exemplary SMP blends for orthodontic appliance applications include poly(vinyl acetate) (PVAc) with poly(lactic acid) (PLA), PVAc with poly(vinylidene fluoride) (PVDF), and poly(alkyl methacrylate)s such as PMMA, with PVDF. These systems show miscibility in the molten state for all blend ratios, with the PVAc and poly(alkyl methacrylate)s (PMMA, PEMA, among others) being totally amorphous, while PLA and PVDF, are each semicrystalline, both having a degree of crystallinity in the pure state of about 50%. The degree of crystallinity of the blends can be varied between 0 and about 50% according to the blend ratios and processing conditions. Dynamic mechanical analysis reveals that such a crystalline phase yields physical crosslinking, the degree of crystallinity controlling the rubbery modulus. The T_{g} of the amorphous phase then serves as the shape memory transition temperature and could be tailored between the T_{g}'s of the two homopolymers. PVC behaves quite similarly to the other two crystalline polymers in such miscible blends. The stiffness near room (25° C.) and body temperature (37° C.) can be reinforced by introducing rigid fillers or fibers, including glass, graphite, and boron nitride.

Exemplary orthodontic devices that can be fabricated with the SMP blends include ligatures, self-ligating brackets, and the like. The blend can be prepared via melt blending or solvent casting. Furthermore, by varying the composition and annealing conditions, materials with different critical transition temperatures and mechanical responses can be achieved. For example, PMMA and PVDF blends have a glassy stiffness and tailorable transition temperature of about 50° C. Furthermore, PMMA-PVDF blends have proven biocompatibility. Other suitable blends include PLMMA (L=lauryl) copolymer blended with PVDF.

Shape Memory Semicrystalline Thermoplastic Polyurethanes

Suitable shape memory semicrystalline thermoplastic polyurethanes include those disclosed in application Ser. No. 10/683,167 entitled “Shape memory polymers based on semicrystalline thermoplastic polyurethanes bearing nanostructured hard segments”, filed Oct. 10, 2003 and application Ser. No. 11/111,388 filed on Apr. 21, 2005 both of which are incorporated by reference herein in their entirety.

The polyurethane SMPs can be prepared by reacting (A) a polyol, (B) a chain extender dihydroxyl-terminated POSS and (C) a diisocyanate, wherein POSS stands for a polyhedral silsesquioxane diol. The polyol (A) can be polyethylene glycol (PEG), polycaprolactone (PCL) diol, polycyclooctene (PCO), trans-1,4 butadiene, transisoprene, polynorbornene diol and polymethacrylate copolymer.

The chain extender dihydroxyl-terminated POSS (B) can be a compound containing a polyhedral oligosilsesquioxane moiety and a diol moiety, wherein a linking group links the two moieties. Commercially available polyhedral oligosilsesquioxane diols include those provided by Hybrid Plastics® Hattiesburg, Miss. or Aldrich Chemical (see generally “Silsesquioxanes, Bridging the Gap Between Polymers and Ceramics”, Chemfiles, Vol. 1, No. 6, 2001 (Aldrich Chemical). Exemplary polyhedral oligosilsesquioxane diols include 1-(2,3-propanediol)propoxy-3,5,7,9,11,13,15-isobutylpentacyclo-[9.5.1.1^{3,9}.1^{5,15}.1^{7,13}]octasiloxane (“1,2-propanediolisobutyl-POSS” CAS # 480439-49-4); 1-(2,3-propanediol)propoxy-3,5,7,9,11,13,15-cyclohexylpentacyclo-[9.5.1.1^{3,9}.1^{5,15}.1^{7,13}]octasiloxane (“1,2-propanediolcyclohexyl-POSS”); 2-ethyl-2-[3-[[(heptacyclopentylpentacyclo-[9.5.11.1^{3,9}.1^{5,15}. 1^{7,13}]octasiloxanyl)oxy]dimethylsilyl]-propoxy]methyl]-1,3-propanediol (“TMP cyclopentyldiol-POSS” or “TMP Diolcyclopentyl-POSS”, CAS 268747-51-9); 2-ethyl-2-[3-[[(heptacyclohexylpentacyclo-[9.5.1.1^{3,9}.1^{5,15}.1^{7,13}]octasiloxanyl)oxy]dimethylsilyl]-propoxy]methyl]-1,3-propanediol (“TMP cyclohexyldiol-POSS”); 2-ethyl-2-[3-[[(heptaisobutylpentacyclo-[9.5.1.1^{3,9}.1^{5,15}.1^{7,13}]octasiloxanyl)oxy]dimethylsilyl]-propoxy]methyl]-1,3-propanediol (“TMP isobutyldiol-POSS” or “TMP diolisobutyl-POSS”); 1-(2-trans-cyclohexanediol)ethyl-3,5,7,9,11,13,15-cyclohexanepentacyclo-[9.5.1.1^{3,9}.1^{5,15}.1^{7,13}]octasiloxane (“trans-cyclohexanediolcyclohexane-POSS” or “trans-cyclohexanediolcyclohexyl-POSS”); 1-(2-trans-cyclohexanediol)ethyl-3,5,7,9,11,13,15-isobutylpentacyclo-[9.5.1.1^{3,9}.1^{5,15}.1^{7,13}]octasiloxane, (“transcyclohexanediolisobutyl-POSS”, CAS 480439-48-3); and 2-ethyl-2-[3-[[(heptaisobutylpentacyclo-[9.5.1.1^{3,9}.1^{5,15}.1^{7,13}]octasiloxanyl)oxy]-dimethylsilyl]propoxy]propane-1,3-diol.

The diisocyanate (C) can be selected from a large number of diisocyanates and is preferably 4,4′-diphenyl methylene diisocyanate (MDI). Other diisocyanates (C) that are suitable for use in the synthesis of hybrid polyurethane SMPs include: toluene-2,4-diisocyanate (TDI), toluene-2,6diisocyanate, hexamethylene-1,6-diisocyanate (HDI), 4,4′-diphenylmethane diisocyanate (MDI), isophorone diisocyanate (IPDI), and hydrogenate 4,4′-diphenylmethane diisocyanate (H12MDI).

The polyol can be semicrystalline and preferably selected from polyethylene glycol (PEG), polycaprolactone (PCL) diol, polycyclooctene (PCO), trans-1,4 butadiene, transisoprene or it can be amorphous in which case it can be polynorbornene diol and/or polymethacrylate copolymer.

The SMP polyurethanes demonstrate sharp and tunable transition temperatures, adjustable stiffness above their transition temperatures, and thermal processabilty above the melting point of the POSS domains. The hybrid polyurethanes also show excellent shape recovery effect at the recovery temperature and a retracting force which is adjustable according to the composition of the POSS. They also possess a unique property that is different from the other shape memory polymers in that the current disclosure (in the PEG embodiment) can be triggered to recover by moisture (liquid or vapor) in addition to heating. For the thermal triggering mechanism, the range can be about 30° C. to about 60° C. according to the ratio of the components used and (importantly) thermal annealing to achieve steady-state (equilibrium) crystallinity is important. The recovery can be finished within seconds when heated 20° C. above the transition temperature. The additional advantages of the materials include that the materials are rigid at room temperature, the polymers generally are biocompatible and in some cases biodegradable.

Any of the SMP polyurethane polymers mentioned above may be filled with, for example, nanoparticles of boron nitride, silica, titanium dioxide, montmorillinite, clay, Kevlar® staple, aluminum nitride, barium and bismuth subcarbonate. Clay and silica can be used, for example, to increase the modulus of the plastic. Dispersing agents and/or compatibilizing agents may be used, for example, to improve the blending of polymers and the blending of polymers with fillers. Dispersing agents and/or compatibilizing agents include, for example, ACRAWAX® (ethylene bis-stearamide), polyurethanes and ELVALOY® (acrylic functionalized polyethylene).

Crosslinked Liquid Crystalline Polymer with Two-Stage Shape Recovery

Suitable crosslinked liquid crystalline polymers include those disclosed in provisional application Ser. No. 11/204,517 entitled Crosslinked Liquid Crystalline Polymer, Method for the Preparation Thereof, and Articles Derived Therefrom, filed Aug. 16, 2005 incorporated by reference herein in its entirety. One embodiment is a crosslinked polymer obtained on crosslinking an uncrosslinked polymer comprising repeating units having the structure 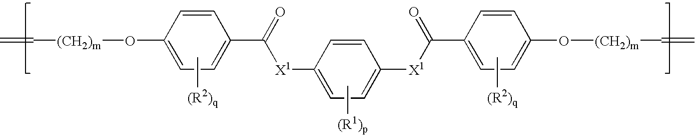
wherein each occurrence of R¹ is independently selected from C₄-C₁₀ tertiary alkyl, C₆-C₁₂ primary or secondary alkyl, C₄-C₁₀ tertiary alkoxy, C₆-C₁₂ primary or secondary alkoxy, unsubstituted or substituted phenoxy (—OPh), unsubstituted or substituted thiophenoxy (—SPh), unsubstituted or substituted benzyl (—CH₂Ph), unsubstituted or substituted benzoyl (—C(═O)Ph), unsubstituted or substituted phenyl sulfonyl (—S(═O)₂Ph), unsubstituted or substituted phenyl sulfinyl (—S(═O)Ph); p is 1, 2, 3, or 4; each occurrence of R² is independently C₁-C₁₂ hydrocarbyl; each occurrence of q is independently 0, 1, 2, 3, or 4; each occurrence of m is independently 1, 2, 3, 4, or 5; and each occurrence of X¹ is —O— or —NH—. When the value of m is greater than 5, the crosslinked polymer tends to exhibit smectic rather than nematic phase behavior. In one embodiment, each occurrence of m is 3. In one embodiment, R¹ is t-butyl and p is 1. In one embodiment, each occurrence of q is 0. In one embodiment, each occurrence of X¹ is —O—. In one embodiment, R¹ is t-butyl and p is 1, each occurrence of q is 0, each occurrence of m is 3, and each occurrence of X¹ is —O—. As used herein, the term “hydrocarbyl”, whether used by itself, or as a prefix, suffix, or fragment of another term, refers to a residue that contains only carbon and hydrogen. The residue may be aliphatic or aromatic, straight-chain, cyclic, bicyclic, branched, saturated, or unsaturated. It may also contain combinations of aliphatic, aromatic, straight chain, cyclic, bicyclic, branched, saturated, and unsaturated hydrocarbon moieties. The hydrocarbyl residue, when so stated however, may contain heteroatoms over and above the carbon and hydrogen members of the substituent residue. Thus, when specifically noted as containing such heteroatoms, the hydrocarbyl residue may also contain carbonyl groups, amino groups, hydroxyl groups, or the like, or it may contain heteroatoms within the backbone of the hydrocarbyl residue. Similarly, when phenoxy, thiophenoxy, benzyl, benzoyl, sulfonyl, and sulfinyl residues are referred to as “substituted”, they may comprise one or more substituents that do not interfere with the synthesis or properties of the crosslinked polymer such as, for example, C₁-C₆ alkyl, C₁-C₆ alkoxy, halogen (including fluorine, chlorine, bromine, and iodine), hydroxyl, amino, C₁-C₆ alkylamino, C₂-C₁₂ dialkylamino, C₂-C₁₂ acyl, amido, C₂-C₁₂ alkylamido, C₃-C₁₂ dialkylamido, and the like.

In another embodiment, the uncrosslinked polymer comprises, in addition to the repeating units defined above, other repeating units so as to yield copolymers. In one embodiment, the other repeating units form flexible segments whose homopolymers are not liquid crystalline. Other repeat units include those formed from polymerization of α,ω-divinyl molecules, such as butadiene and α,ω-divinylsiloxanes, and unsaturated cyclic hydrocarbons subject to ring-opening polymerization, including cyclooctene, cyclooctadiene, and norbornene.

In one embodiment, the uncrosslinked polymer comprises about 5 to about 100 of the repeating units. Within this range, at least 10 repeating units are preferred.

The uncrosslinked polymer may be crosslinked by any method capable of forming a carbon-carbon single bond between an aliphatic carbon atom in a first uncrosslinked polymer chain and an aliphatic carbon atom in a second uncrosslinked polymer chain. For example, crosslinking may comprise reacting the uncrosslinked polymer with a free radical precursor under conditions suitable for generating free radicals from the free radical precursor. As another example, the uncrosslinked polymer may be crosslinked with a particle beam or electromagnetic radiation. Specifically, crosslinking may comprise exposing the uncrosslinked polymer to an electron beam or electromagnetic radiation having a wavelength ranging from about 0.1 picometer (i.e., gamma radiation) to about 400 nanometers (i.e., ultraviolet irradiation). When the composition is cured by exposure to electromagnetic radiation, particularly ultraviolet light, the composition may further include a photoinitiator. Suitable photoinitiators are known in the art and are commercially available from, for example, Sigma-Aldrich. Suitable photoinitiators include, for example, benzil ketals, α-dialkoxyacetophenones, α-hydroxyalkylphenones, α-aminoalkylphenones, titanocenes, and the like, and combinations thereof.

In one embodiment, crosslinking comprises reacting about 0.1 to about 30 percent of the aliphatic carbon-carbon double bonds in the uncrosslinked polymer. Within this range, the percentage of reacted aliphatic carbon-carbon double bonds may specifically be at least about 1, more specifically at least about 5, still more specifically at least about 10. Also within this range, the percentage of reacted aliphatic carbon-carbon double bonds may specifically be up to about 25, more specifically up to about 20.

The composition may comprise about 1 to 100 weight percent of the crosslinked polymer. Within this range, the crosslinked polymer amount may specifically be at least about 5 weight percent, more specifically at least about 10 weight percent. Also within this range, the crosslinked polymer amount may specifically be up to about 99 weight percent, more specifically up to about 95 weight percent, still more specifically up to about 90 weight percent.

In addition to the crosslinked polymer, the composition may include various additives to improve properties of the composition and articles formed therefrom. In one embodiment, the composition further comprises an additive selected from liquid crystalline diluents (e.g., the nematic compound n-pentylcyanobiphenyl, which may allow reduction of T_{g} and the nematic-isotropic transition temperature, T_{NI}), rubbers comprising crosslinkable functionality (e.g., polybutadienes, and styrene-butadiene block copolymers, which are useful to reduce the modulus of the composition), reinforcing fillers (e.g., glass fibers, which are useful to increase the modulus of the composition), conductive fillers (including both thermally conductive and electrically conductive fillers; e.g., graphite, carbon nanotubes, and boron nitride, which are useful to increase the thermal conductivity of the composition and thereby accelerate shape memory effects that involve heat transfer), and the like, and combinations thereof.

One embodiment is an orthodontic article comprising any of the above-described compositions. The two-stage shape memory behavior of the crosslinked polymers makes them particularly useful for such applications as dental ligation mechanisms (e.g., orthodontic brackets, “O-rings”). Two temporary shapes can be stored in memory, allowing for complex deployment, prescribed during processing, on simple heating. The two temporary shapes, combined with the equilibrium shape under deployment conditions, make it possible for the article to exhibit three shapes as a function of temperature.

The SMP orthodontic appliances prepared by any one of the foregoing SMPs can be fabricated using known methods in the art, including, as dictated by the SMP polymer type, profile extrusion, injection molding, die cutting, casting, dip-coating, compression molding, blow-molding, rotational molding, rapid prototyping, solid freeform fabrication, and the like.

The SMPs also desirously exhibit stain resistance, particularly to food such as tea, coffee, wine, grape juice, and the like. Furthermore, the SMP can be chosen to have limited moisture absorption and correspondingly retention of mechanical properties.

For example, the SMP appliance is “substantially stain free” after exposure to a food at 37° C. for one week. As used herein “substantially stain free” means there is no change in color of the SMP material upon inspection with the naked eye.

In one embodiment, the SMP appliance absorbs less than about 2 weight percent water after immersion in water for one month at room temperature.

In one embodiment, the orthodontic device is prepared from a shape memory polymer that is biocompatible, biodegradable, or biocompatible and biodegradable.

In another embodiment, the orthodontic device is prepared from a shape memory polymer that is not biodegradable.

In one embodiment, the orthodontic device is prepared from a shape memory polymer that is transparent and colorless. In another embodiment, the shape memory polymer is dyed or tinted to a desired color (black, blue, red, yellow, pink, violet, green, orange, white, etc.). In yet another embodiment, the shape memory polymer is opaque.

The orthodontic appliance prepared from a SMP can exhibit a rubber modulus (E′) of about 0.5 to about 10 MPa that does not relax more than about 10%, specifically not more than about 8%, and more specifically not more than about 5% over the course of 14 days.

In one embodiment, a method of performing orthodontic treatment comprises treating a patient with any of the orthodontic appliances described herein.

Further embodiments include a method of performing orthodontic treatment comprising treating a patient with any one of the orthodontic appliances described herein. In one embodiment, the patient is treated with a removable aligner appliance comprising discrete sections of a shape memory polymer, wherein the discrete sections can be independently activated for shape change to produce tooth movement. The activation may be performed sequentially to produce desired tooth movement.

The invention is further illustrated by the following non-limiting examples.

### EXAMPLE 1

### SMP Ligature

A SMP ligature is prepared from a miscible blend of PMMA/PVDF by molding or a copolymer of MMA-BMA by casting synthesis. The permanent shape is set as a closed-loop “Ω” shape as shown in FIG. 1(a). The ligature (also referred to as a clamp) is heated above its transition temperature and opened for easy application, as in FIG. 1(b). The clamp is then fastened by heating up to the transition temperature in the patient's mouth (FIG. 1(c)).

### EXAMPLE 2

### SMP Self-Ligating Bracket with SMP Locking Mechanism

A SMP ligature clamp of a self-ligating bracket is also made of a miscible blend of PMMA/PVDF by molding, or with a copolymer of MMA-BMA by casting synthesis with a permanent shape set to be a “C” shape as shown in FIG. 2(a). The “up” cap is opened by straightening in the rubbery stage to the shape shown in FIG. 2(b); the bracket cap is then closed as shown in FIG. 2(c) and finally thermal triggered to fasten in place in FIG. 2(d).

### EXAMPLE 3

### SMP Force Module

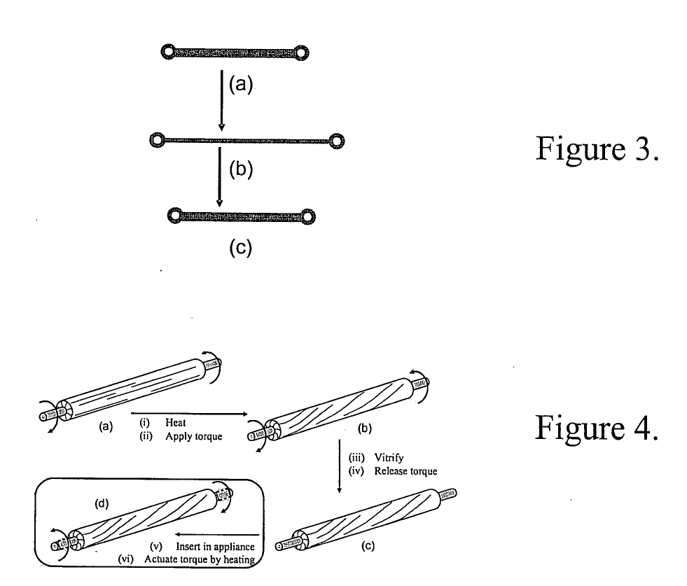

An SMP force module is described schematically in FIG. 3. An elastic spring that adjusts the tooth position is manufactured from a shape memory elastomer: crosslinked polycyclooctene having a sharp transition from about 28 to about 33° C. Square cross-section modules are punched out of 1 mm thick compression moldings of cured PCO by use of a fabrication punch or by injection molding in a suitable cavity of a mold. Outside the mouth, the force module is pre-stretched from an initial length to various lengths (of a set). This secondary shape is then fixed in ice water (FIG. 3(b)). When applied in the mouth, the shape recovery is triggered by the mouth temperature (37° C.), and the applied force leads to tooth re-positioning as with chain elastics.

### EXAMPLE 4

### SMP Torque Actuation Module

A torque actuation module is fabricated by dip-coating a MMA-BMA copolymer around the thin NiTi wire followed by curing (FIG. 4(a)). The coated wire is heated up to the SMP's transition temperature and twisted to a secondary shape (FIG. 4(b)). This secondary shape can be further completely fixed by vitrification of the SMP with torque applied. When the torque is released, the vitrified SMP holds the secondary shape from recovering (FIG. 4(c)). The deformed wire is then inserted between brackets and the stored torque is actuated by heating the polymer above its transition again (FIG. 4(d)).

### EXAMPLES 5.-9

### Evaluation of Stain Resistance, Water Absorption, Degradation, and Mechnical Properties for the following SMPs were Explored

1. Castable Shape Memory Polymer(“CSMP”):

Two batches of an optically clear, castable shape memory polymer were synthesized for the purpose of evaluating stain resistance, water absorption, degradation, and mechanical tests. The composition was a copolymer of butyl methacrylate (BMA, 66.7 wt-%), methyl methacrylate (MMA, 28.6 wt-%) and tetraethylene glycol dimethacrylate (TEGDMA, 4.8 wt-%). Monomers, crosslinker, and initiator (AIBN) were accurately measured, mixed, and injected between two glass slides that were sealed around the edge and separated using an o-ring. Polymerization was then achieved using a heating program of 50° C./48 hrs, 80° C./48 hrs, 100° C./24 hrs, and 120° C./10 hrs in an oven. Copolymers thus obtained were optically clear and featured a glass transition temperature of T_{g}˜50° C.

2. Chemically Crosslinked Polycyclooctene Elastomer (“x-PCO”):

Chemically crosslinked PCO was prepared to yield a semicrystalline rubber with Tₘ=45° C. In particular, PCO (Vestenamer®8012) with an original melting point of Tₘ=58° C. was melt blended with dicumyl peroxide (DCP, 1.0-1.3 wt-%) at 80° C. for 10 minutes, and thermally cured between heat press at 180° C. for 0.5 hr. A milky colored film was obtained after thermal cure. The material featured a relatively temperature-independent elastic modulus for temperature above Tₘ. This material was used for stain resistance, water uptake, and mechanical tests.

3. Radiation Crosslinked Polycyclooctene Elastomer (“gx-PCO”):

PCO (Vestenamer®8012) with an original melting point of Tₘ=58° C. was first heat pressed to a film with thickness of 1.5 mm and then crosslinked using gamma ray radiation. The gamma ray dose for each sample ranged from 100 kGy to 400 kGy. These samples were used for comparison of mechanical properties with chemically crosslinked PCO.

4. Blends of Polylactide (PLA) with Poly (Vinyl Acetate) (PVAc) (“PLA/PVAc”):

A semicrystalline PLA (med-d) (undetermined MW) was melt-blended with an amorphous PVAc having a molecular weight of 500,000 g/mol. The ratio of the blend is PLA:PVAc=40:60 (wt:wt). Blending was performed in a Brabender batch compounder at 180° C. for 10 minutes, followed by heat-pressing to a film having thickness of 1 mm at the same temperature for 5 minutes. The samples were then annealed in the same heat press at 100° C. for 2 hours to assure that crystallization had reached an equilibrium level. The samples were prepared for stain resistance testing. A pure PLA film was also heat-pressed at 180° C. for 10 minutes and a pure PVAc was also heated pressed at 100° C. for 10 minutes, each serving as controls for comparison.

5. Blends of Poly(vinylidene Difluoride) (PVDF) with Poly(vinyl acetate) (PVAc) (“PVDF/PVAc”):

A semicrystalline PVDF (unknown MW) was melt blended with an amorphous PVAc having a molecular weight of 500,000 g/mol. The blend composition was PVDF:PVAc=40:60 (wt:wt). Blending was performed in a Brabender batch compounder at 180° C. for 10 minutes, followed by heat-pressing to a film having thickness of 1 mm at the same temperature for 5 minutes. Samples were then annealed in the same heat press at 100° C. for 2 hours to ensure that the crystallinity had reached equilibrium. The samples were for stain resistance testing. A pure PVDF film was also heated pressed at 180° C. for 10 minutes as a control.

6. Control: Commercial O-Rings (“Control O-Ring”)

White and clear plastic orthodontic O-rings sold under the name Mini-tie available from Ortho Organizers, San Marcos Calif. were used as controls. These materials were examined for strain resistance and stress relaxation. The O-rings were heated pressed to thinner, flat films with a thickness of about 1 mm before use.

### EXAMPLE 5

### Stain Resistance

Samples of CSMP, x-PCO, PLA/PVAc, PVDF/PVAc, and Control O-rings were explored for stain resistance in a variety of staining solutions. The solutions included 1) red wine (Estate Cellars, used as received), 2) black tea (Lipton, 1 tea bag of black tea prepared in 250 ml deionized (DI) water, boiled for 5 minutes), 3) yellow mustard (diluted with DI water at the ratio of mustard: DI water=1:5 (vol:vol)), 4) black, caffeinated coffee, 100% Arabica coffee, 15 grams in 500 ml of DI water, boiled for 10 minutes, and 5) DI water as control solution. After immersion in these solutions for the stated times, the samples were taken out and rinsed DI water to remove any loosely attached stains. The samples were visually inspected for staining and rated on a scale of 0 to 5:0=no stain; 1=light stain; 2=moderately light stain; 3=moderate stain; 4=moderately heavy stain; 5=heavy stain. Tables 2a and 2b provide the results of the stain resistance study for the samples according to the time indicated.

TABLE 2a

| | Control | Control | | | PVDF/ |
|---|---|---|---|---|---|
| | O-ring | O-ring | | | PVAc |
| | White | Clear | x-PCO | CSMP | (40:60) |
| Red wine | | | | | |
| 2 days | 2 | 2 | 0 | 0 | 3 |
| 1 week | 3 | 3 | 0 | 0 | 4 |
| 2 weeks | 3 | 3 | 1 | 0 | 5 |
| 4 weeks | 4 | 4 | 4 | 0 | 5 |
| Black tea | | | | | |
| 2 days | 2 | 2 | 0 | 0 | 1 |
| 1 week | 3 | 3 | 0 | 0 | 1 |
| 2 weeks | 3 | 4 | 0 | 0 | 2 |
| 4 weeks | 4 | 5 | 0 | 0 | 2 |
| Mustard | | | | | |
| 2 days | 2 | 2 | 1 | 1 | 2 |
| 1 week | 2 | 2 | 2 | 1 | 2 |
| 2 weeks | 2 | 3 | 2 | 1 | 2 |
| 4 weeks | 3 | 3 | 3 | 1 | 2 |
| DI water | | | | | |
| 2 days | 0 | 0 | 0 | 0 | 0 |
| 1 week | 0 | 0 | 0 | 0 | 0 |
| 2 weeks | 0 | 0 | 0 | 0 | 0 |
| 4 weeks | 0 | 0 | 0 | 0 | 0 |

TABLE 2b

| | Control | | | | |
|---|---|---|---|---|---|
| | O-ring | | PLA/ | | |
| | White | CSMP | PVAc | PVDF | PVAc |
| Red wine | | | | | |
| 1 day | 2 | 0 | 2 | 0 | 3 |
| 2 weeks | 2 | 0 | 3 | 0 | 4 |
| 4 weeks | 2 | 0 | 3 | 0 | 5 |
| Black tea | | | | | |
| 1 day | 2 | 0 | 1 | 0 | 1 |
| 2 weeks | 3 | 0 | 2 | 0 | 2 |
| 4 weeks | 3 | 0 | 3 | 0 | 4 |
| Black | | | | | |
| coffee | | | | | |
| 1 day | 1 | 0 | 1 | 0 | 0 |
| 2 weeks | 2 | 0 | 1 | 0 | 1 |
| 4 weeks | 2 | 0 | 2 | 0 | 2 |
| DI water | | | | | |
| 1 day | 0 | 0 | 0 | 0 | 0 |
| 2 weeks | 0 | 0 | 0 | 0 | 0 |
| 4 weeks | 0 | 0 | 0 | 0 | 0 |

As illustrated by the results in Tables 2a and 2b, the two controls were stained in all of the staining solutions tested. However, PVDF and CSMP were quite stain resistant after moderate exposure in the staining solutions. x-PCO was stain resistant in both red wine and black tea.

PVAc was stained in the tests performed. It is hypothesized that the staining is due to hydrolysis of the acetate side chain, allowing reaction with the small colorant molecules in the solution. Furthermore, it was determined that PVAc softened in the red wine due the possible hydrolysis reaction in alcohol solution. The blends containing PVAc, therefore, show staining due to the presence of the PVAc component. To avoid the discoloration problem, these blends can be tinted or colored to have darker hues to mask any staining that may occur during use. When materials of lighter colors are desired, PVAc can be replaced with a stain-resistant species, such as an alkyl-methacrylate copolymer to prevent the stain problem while still allowing the desirable shape memory properties.

Further experiments were performed with a prolonged time of exposure to the selected staining materials (up to 1 month). Staining was evident for all the samples although the CSMP shows excellent stain resistance. Also, the x-PCO shows a better stain resistance quality compared with the O-ring control samples.

Further analysis of the stain resistance mechanism of these samples indicate that the majority of the SMPs are surface staining which can be avoided by surface modifications (see Table 3).

TABLE 3
Staining mechanisms of the sample materials

| | Control | Control | | | |
|---|---|---|---|---|---|
| | O-ring | O-ring | | | PVDF/PVAc |
| | White | Clear | x-PCO | CSMP | (40:60) |
| Red wine | Bulk | Bulk | Surface | Stain resistant | Surface |
| | staining | staining | staining | | staining |
| Black tea | Surface | Surface | Stain resistant | Stain resistant | Stain resistant |
| | staining | staining | | | |
| Mustard | Bulk | Bulk | Bulk staining | Stain resistant | Surface |
| | staining | staining | | | staining |

### EXAMPLE 6

### Water Absorption Analysis

Water uptake of CSMP and x-PCO was investigated by two methods: water absorption dynamics and equilibrium water uptake comparison, both at 37° C. Dynamic tests were performed by first conditioning the samples in a vacuum oven at 50° C. to remove any absorbed and adsorbed water vapor. The conditioned samples were then immersed in 37° C. DI water. The weight change with time was recorded, calculated as a mass fraction of the original mass, and compared. Equilibrium water uptake was calculated from the time-asymptotic weight values. Five samples were tested and the average was used in this experiment.

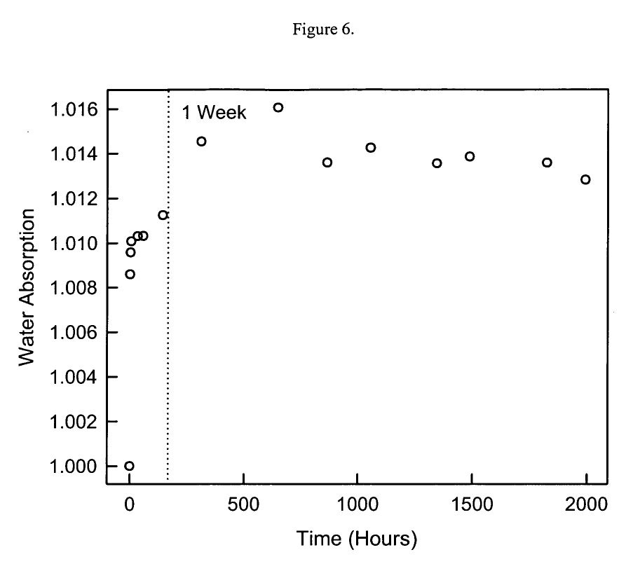

Water Uptake results of CSMP: Dynamic water absorption data for CSMP are plotted in FIG. 6. As illustrated, the majority of water absorption occurred within the first 12 hours (˜1.1% mass gain), while an equilibrium water mass gain of 1.35 wt-% was observed after about 2 weeks. It is noted that exact time dependence of mass gain depends on sample thickness, increasing to equilibrium more quickly for thinner samples.

The impact of water exposure on CSMP mechanical properties was examined. As the material is chemically crosslinked, the molecular weight changes (of potential relevance to any mechanical property reduction) cannot be detected. Therefore, weight change and mechanical properties of samples before and after water absorption were measured. As illustrated in FIG. 6, only slight weight gain is indicated, not weight loss.

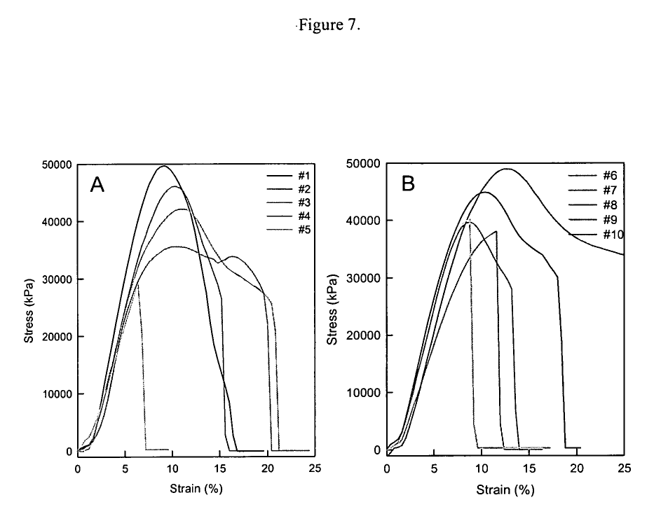

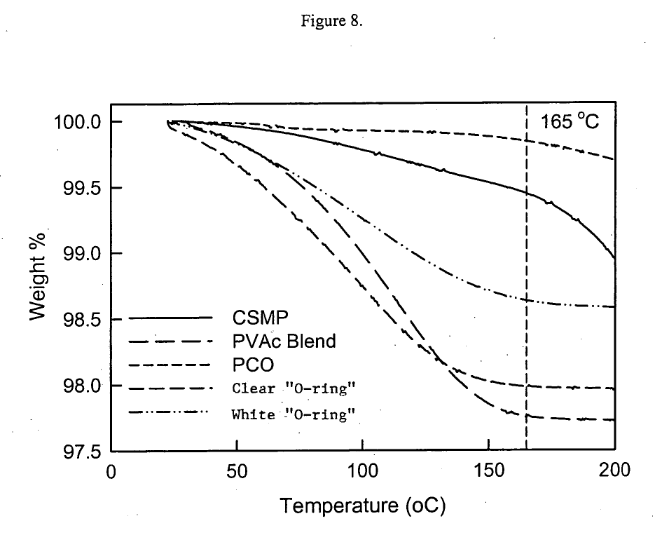

FIG. 7 illustrates a summary of stress strain behaviors of dry (A) and water saturated (B) CSMP at room temperature. Mechanical tests (FIG. 7) indicate that there was no detectable degradation as the dry and water saturated samples show a similar stress strain response. Thermal analysis was performed and results show that for dry samples, a T_{g} of 52±1.6° C. was observed. For water saturated samples, a slightly lower Tg=49.1±1.6° C. was measured on second heating. (On first heating, a large enthalpy relaxation peak was observed, obscuring T_{g} measurement, due to the physical aging phenomenon). The T_{g} values from second heating reflects the effects of water plasticization. A 3° C. decrease was detected for this 1.3% of water. This is determined not to be significant for the orthodontic application as the material still retains sufficient stiffness.

Comparison of equilibrium water uptake between different samples was done by measuring the water content gravimetrically. In particular, weight loss upon heating water-equilibrated (>1 month) samples in a thermogravimetric analyzer (TGA) was measured and the data are shown in FIG. 8. This experiment has two assumptions: 1) the polymer will not dissolve/degrade in water, and 2) the samples have been saturated to equilibrium in water. Results for water uptake indicate the following in terms of water uptake: PVAc/PVDF>Control O-ring Clear>Control O-ring White>CSMP>x-PCO. All the samples absorb less than 2% of water and CSMP and x-PCO absorb<0.5 wt-% water.

### EXAMPLE 7

### Tensile Testing of CSMP and x-PCO

The stress-strain behavior of CSMP and x-PCO were examined using a Minimat™ apparatus at a strain rate of 1 mm/min, and at room temperature. Both experiments were performed at room temperature and rubbery stage (T=T_{c}+20° C.). A dog bone shape was chosen for the test specimen and were machined from CSMP and PCO sheets with dimensions of about length×width×thickness=10 mm×3 mm×1.2 mm.

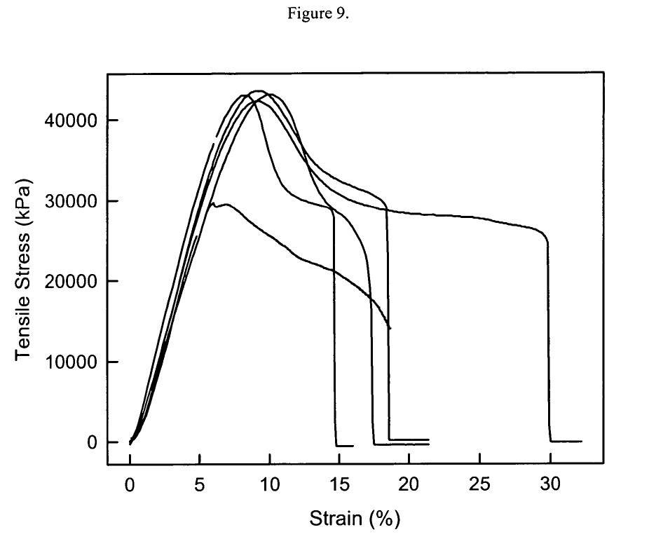

The mechanical properties of CSMP are provided in FIG. 9. As shown, the CSMP has a yield stress (σ_{y}) of 43±0.5 MPa, a yield strain (ε_{y}) of 9.1±0.8%, and strain to failure (ε_{b}) of 19.8±5.9%. It is suggested that increasing the temperature to 37° C. would result in a decrease of the yield stress somewhat and an increase in the yield strain and strain to failure.

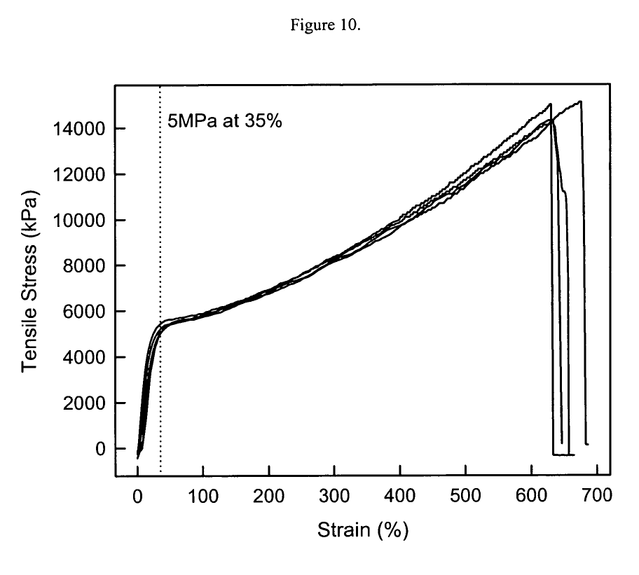

Room temperature mechanical properties of x-PCO (1% DCP, cured at 180° C. for 30 min) was also tested (FIG. 10). Results show that within 35% strain, this material is very elastic, and has a yield point at about 35%. Beyond this strain, the stress continues growth with strain, but at a lower rate. This curve shape is common to semicrystalline polyolefins. The material breaks at a large strain=650%. Materials having other crosslink densities were measured and compared with this sample (See Example 8 below).

### EXAMPLE 8

### Comparison of Chemical Versus Radiation Crosslinking Methods and Crosslinking Density to the Mechanical Properties of PCO

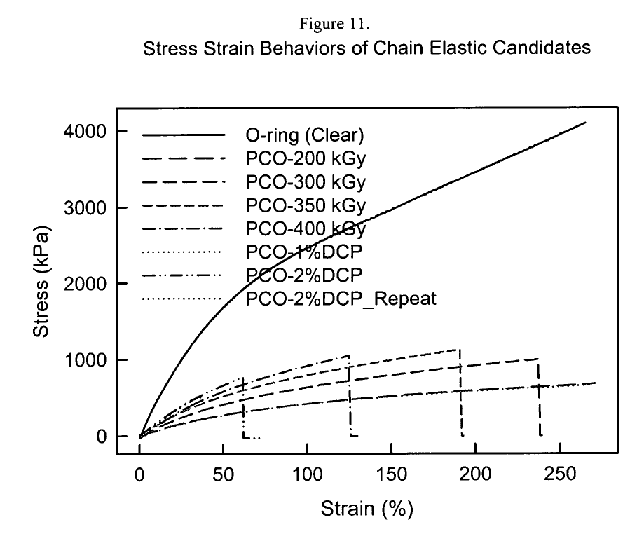

Stress-strain behavior of thermally and radiatively crosslinked PCO were compared at a temperature greater than Tₘ (Tm+10° C., 55° C.), FIG. 11 and Table 4. As indicated in FIG. 11, different crosslinking techniques were used and various crosslinking densities were achieved and compared. The solid, black curve is a commercially used O-ring that showed a higher stress strain curve than the SMP materials.

TABLE 4
Tensile stresses at 100% strain of crosslinked PCO
at 55° C. (Tm + 10° C.).

Dose in kilogray

| | 200 | 300 | 350 | 400 | 1% | Control |
|---|---|---|---|---|---|---|
| | kGy | kGy | kGy | kGy | DCP | O-ring |
| Tensile | 418 | 634 | 792 | 913 | 415 | 2460 |
| Stress | | | | | | |
| (kPa) | | | | | | |

The results indicate that PCO crosslinked with 1% DCP showed a low stress and high strain to failure (>250%), which compares to that of PCO crosslinked with dosage of 200 kGy. Doubling the DCP amount results a higher stress, but poor strain to failure to less than 100%. However, increasing the radiation dosage will gradually increase the stress and decrease the strain to failure. Doubling the radiation dosage leads a doubling of the resulting stress, and a relatively high strain to failure was retained (>120%). This is a further advantage of radiation crosslinking compared with thermal curing.

Also indicated from the data in FIG. 11 and Table 4, it has been found that the PCO materials are more compliant than the currently used “chain elastics”, if compared with the same dimensions. Furthermore, desired forces on the order of 1 gram-force are easily achieved with x-PCO and gx-PCO.

### EXAMPLE 9

### Stress Relaxation Test of x-PCO and Commercially Available Plastic O-Ring

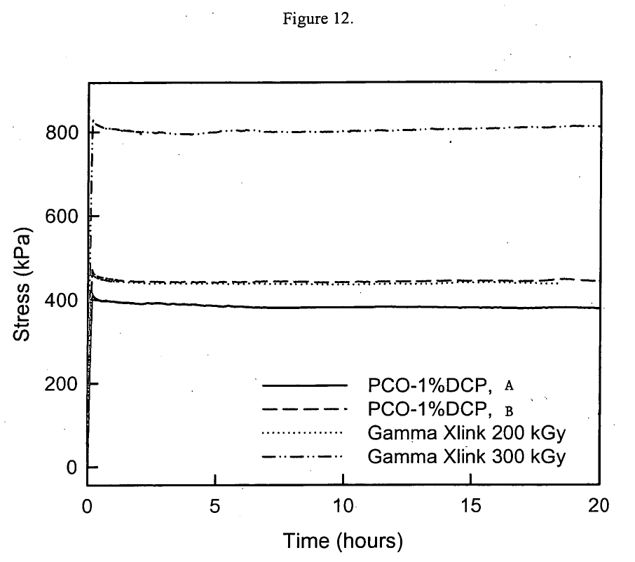

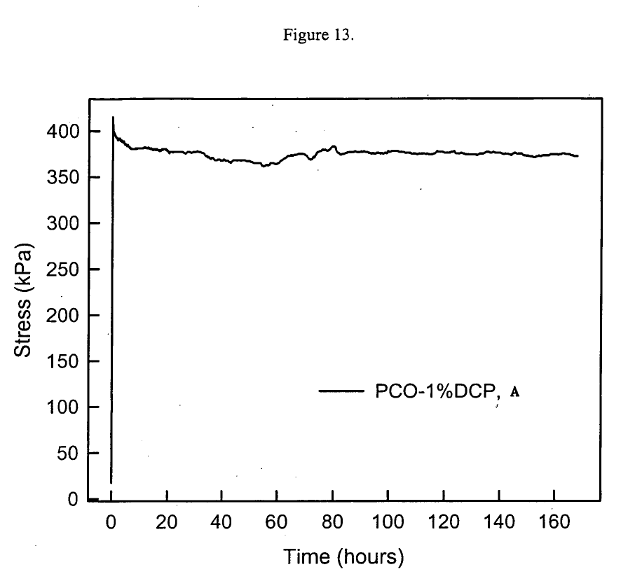

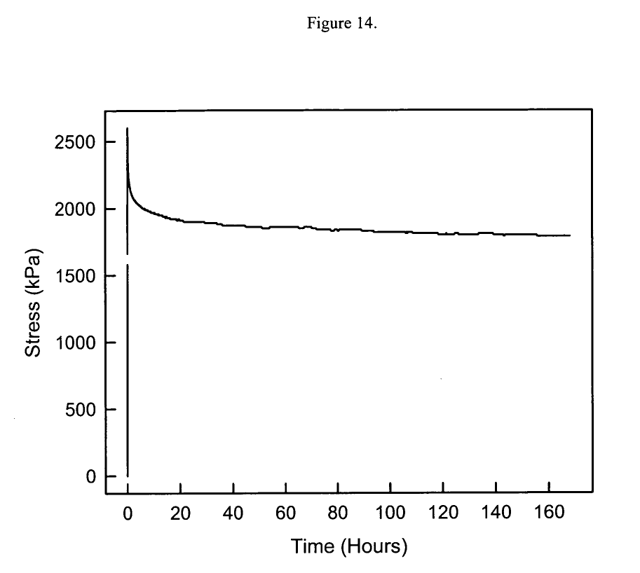

The stress relaxation properties (force retaining properties) of x-PCO and a commercially used O-ring, which is expected to have similar chemical structure and stress relaxation properties with chain elastic, were measured using a Minimat™ apparatus. Results are provided in FIGS. 12-14, which show that while the commercially available O-ring loses 30% of its force within 1 week (FIG. 14), x-PCO retains 90% of its force for 1 week (FIG. 13). Close inspection of the data indicates that for the O-ring, about 20% of the force was lost within the first 5 hours, with continued force decay occurring over time. By comparison, for x-PCO most of the force decay occurred within 1 hour and a steady force will be kept within 1 day.

Force retention over time is needed for the orthodontic force module application. The ideal force module should keep its force from decaying with time, but in reality, all polymers will have some force decay with time, called stress relaxation. The force decay problem of known materials (not shape memory) will lead to high force at initial clinical time and insufficient force at the later stages. Therefore, frequent change of chain elastics is required for a successful treatment. The excellent force retaining property of x-PCO materials as shown in Example 9, in addition to shape memory functionality, will lead to more constant force during treatment and hence more comfortable treatment and less clinical visits.

Several other crosslinked PCOs were also tested and the results were plotted in FIG. 12. All samples show similar and excellent force retaining properties. Comparisons of the length changes of two stretched and stress relaxed PCOs were explored. Samples were released at relaxation temperature (55° C.) and frozen immediately after being unloaded. An original sample cut without any stretching was used as a reference. The results indicate that for crosslinked PCO, even stretched for one week, the sample length returns almost completely to its original length without noticeable permanent set (note: unloading was achieved at 55° C., the test temperature). In contrast, for O-ring materials, an obvious permanent set was observed only after two days into the stress relaxation experiment. The O-ring sample was released at relaxation temperature (37° C.) and measured immediately after unloaded. The resulting elongation was attributed to unrecoverable creep that is attributed to the lack of covalent crosslinks in the material

The terms “a” and “an” herein do not denote a limitation of quantity, but rather denote the presence of at least one of the referenced item. All ranges disclosed herein are inclusive and combinable. All cited patents, patent applications, and other references are incorporated herein by reference in their entirety.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An orthodontic appliance or a component thereof, comprising:
a shape memory polymer selected from the group consisting of
i) a castable shape memory polymer prepared by reacting A) a high-T^{g} polymer-forming monomer, B) a low-T_{g} polymer-forming monomer, and C) a multifunctional cross-linking agent;
ii) a crosslinked polycyclooctene;
iii) a thermoplastic blend shape memory polymer characterized by a T_{g} exceeding room temperature whose rubber modulus and elasticity are derived substantially from physical crosslinks wherein the shape memory polymer comprises a blend of a crystalline polymer selected from the group consisting of poly(vinylidene fluoride), polyglycolides, polylactide and copolymers thereof, poly(hydroxybutyrate), poly(ethylene glycol), polyethylene, polyethylene-co-vinyl acetate, poly(vinyl chloride), poly(vinylidene chloride) and copolymers of poly vinylidene chloride and poly vinyl chloride with an amorphous polymer selected from the group consisting of poly(vinyl acetate), poly methyl acrylate, poly ethyl acrylate, atactic poly methyl methacrylate, isotactic poly methyl methacrylate and syndiotactic poly methyl methacrylate;
iv) a polyurethane shape memory polymer prepared by reacting (A) a polyol, (B) a chain extender dihydroxyl-terminated polyhedral silsesquioxane and (C) a diisocyanate; and
v) crosslinked liquid crystalline polymers;
and wherein the orthodontic appliance is not a removable aligner appliance.

2. The orthodontic appliance of claim 1, wherein the orthodontic appliance is a ligature, a self-ligating bracket, a force module, a torque module, or combinations thereof.

3. The orthodontic appliance of claim 1, wherein the shape memory polymer is a castable shape memory polymer and wherein the high-T_{g} polymer-forming monomer is vinyl chloride, vinyl butyral, vinyl fluoride, vinyl pivalate, 2-vinylnaphthalene, 2-vinylpyridine, 4-vinyl pyridine, vinylpyrrolidone, n-vinyl carbazole, vinyl toluene, styrene, methyl methacrylate, ethyl methacrylate, acryl-functionalized polyhedral silsesquioxane, methacryl-functionalized polyhedral silsesquioxane or combinations thereof; the low-T_{g} polymer-forming monomer is vinyl ethyl ether, vinyl laurate, vinyl methyl ether, vinyl propionate, methyl acrylate, ethyl acrylate, propyl acrylate, butyl acrylate, propyl methacrylate, butyl methacrylate, and combinations thereof; and the multifunctional cross-linking agent is a diacrylate or dimethacrylate.

4. The orthodontic appliance of claim 3, wherein the high-T_{g} polymer-forming monomer is methyl methacrylate and the low-T_{g} polymer-forming monomer is butyl methacrylate.

5. The orthodontic appliance of claim 4, wherein the ratio of methylmethacrylate to butylmethacrylate is from about 20 to about 80 weight percent methylmethacrylate: about 80 to about 20 weight percent butylmethacrylate.

6. The orthodontic appliance of claim 3, wherein the glass transition temperature of the shape memory polymer is about 35 to about 110° C.

7. The orthodontic appliance of claim 3, wherein the orthodontic appliance is a ligature or a self-ligating bracket.

8. The orthodontic appliance of claim 1, wherein the crosslinked polycyclooctene comprises chemically cross-linked polycyclooctene synthesized from cis-cyclooctene.

9. The orthodontic appliance of claim 1, wherein the crosslinked polycyclooctene comprises radiationally cross-linked polycyclooctene synthesized from cis-cyclooctene.

10. The orthodontic appliance of claim 1, wherein the orthodontic appliance is a force module; and wherein the shape memory polymer is a crosslinked polycyclooctene.

11. The orthodontic appliance of claim 1, wherein the thermoplastic blend shape memory polymer is a blend of
poly(vinylidene fluoride), poly(vinyl chloride), poly(vinylidene chloride), a copolymer of poly (vinylidene chloride) and poly (vinyl chloride), or combinations thereof with
a poly(vinyl acetate), poly methyl acrylate, poly ethyl acrylate, atactic poly methyl methacrylate, isotactic poly methyl methacrylate, syndiotactic poly methyl methacrylate or combinations thereof.

12. The orthodontic appliance of claim 1, wherein the shape memory polymer comprises a transition temperature of greater than about 35° C.

13. The orthodontic appliance of claim 1, wherein the shape memory polymer comprises one of the following properties:
a transition temperature of about 25 to about 35° C.;
if the appliance is a bracket, a transition temperature of greater than about 40° C.
a tensile storage modulus of about 0.01 to about 5 GPa;
a rubber modulus (E′) of about 0.5 to about 10 MPa as measured by ASTM D412-98a(2002)e1;
a rubber modulus (E′) of greater than about 10 MPa as measured by ASTM D412-98a(2002)e1;
a rubber modulus (E′) of about 0.5 to about 10 MPa, as measured by ASTM D412-98a(2002)e1, that does not relax more than about 10% over the course of 14 days at room temperature;
stain resistance; and
is substantially stain free after exposure to red wine, mustard, or black tea at 37° C. for one week.

14. The orthodontic appliance of claim 1, wherein the shape memory polymer further comprises a filler, wherein the filler is silica, calcium carbonate, titanium dioxide, glass fibers, boron nitride, aluminum nitride, barium subcarbonate, bismuth subcarbonate, clay, carbon nanotubes, or a combination thereof.

15. The orthodontic appliance of claim 1, further comprising a shape memory metal alloy wire.

16. The orthodontic appliance of claim 1, wherein the orthodontic appliance exhibits at least three shapes as a function of temperature.

17. An orthodontic appliance, wherein the appliance is a removable aligner appliance, comprising:
a shape memory polymer having a T_{g} greater than or equal to about 40° C., wherein the shape memory polymer is
a castable shape memory polymer prepared by reacting i) a high-T_{g} polymer-forming monomer, ii) a low-T_{g} polymer-forming monomer, and iii) a multifunctional cross-linking agent; or
a thermoplastic blend shape memory polymer characterized by a T_{g} exceeding room temperature whose rubber modulus and elasticity are derived substantially from physical crosslinks wherein the shape memory polymer comprises a blend of a crystalline polymer selected from the group consisting of poly(vinylidene fluoride), polyglycolides, polylactide and copolymers thereof, poly(hydroxybutyrate), poly(ethylene glycol), polyethylene, polyethylene-co-vinyl acetate, poly(vinyl chloride), poly(vinylidene chloride) and copolymers of poly vinylidene chloride and poly vinyl chloride with an amorphous polymer selected from the group consisting of poly(vinyl acetate), poly methyl acrylate, poly ethyl acrylate, atactic poly methyl methacrylate, isotactic poly methyl methacrylate and syndiotactic poly methyl methacrylate.

18. The orthodontic appliance of claim 17, wherein the removable aligner appliance comprising discrete sections of a shape memory polymer, wherein the discrete sections can be independently activated for shape change.

19. The orthodontic appliance of claim 17, wherein the removable aligner appliance exhibits at least three shapes as a function of temperature.

20. A method of making an orthodontic appliance, comprising:
preparing an orthodontic appliance of claim 1 by profile extrusion, injection molding, die cutting, casting, dip-coating, compression molding, blow-molding, rotational molding, rapid prototyping, solid freeform fabrication, or combinations thereof.

21. A method of making an orthodontic appliance, comprising:
preparing an orthodontic appliance of claim 16 by profile extrusion, injection molding, die cutting, casting, dip-coating, compression molding, blow-molding, rotational molding, rapid prototyping, solid freeform fabrication, or combinations thereof.
